(19) United States
(12) Patent Application Publication
(10) Pub. No.: US 2002/0104714 A1
(43) Pub. Date: Aug. 8, 2002

(54) Transportable stairlifts

(76) Inventor: John Stewart Jakes, West Yorkshire (GB)

Correspondence Address: MYERS BIGEL SIBLEY & SAJOVEC, PO BOX 37428, RALEIGH, NC, 27627, US

(21) Appl. No.: 10/001,320

(22) Filed: Oct. 15, 2001

(30) Foreign Application Priority Data
Feb. 2, 2001 (GB) 0102659.0

(51) Int. Cl. B65G 67/02

(52) U.S. Cl. 187/200; 414/462; 414/507; 414/921; 187/242

(57) ABSTRACT

A stairlift device comprises passenger carrying means, substantially linear guide means, transporting means, and attachment means, said attachment means being adapted to enable the guide means to be attached to a section of a vehicle, thereby allowing for operation of the stairlift device whilst in attachment to the vehicle, the passenger carrying means being movable along the guide means by the transporting means when the device is in operation.

### CROSS-REFERENCE TO RELATED APPLICATIONS

The present application claims priority to British Patent Application No. 0102659.0, in English, filed Feb. 2, 2001, the disclosure of which is incorporated herein by reference in its entirety.

### FIELD OF THE INVENTION

The present invention relates to stairlifts. In particular, the invention provides a portable stairlift which can be readily transported and subsequently affixed to a vehicle, thereby providing a simple means for demonstration of the stairlift to potential customers at their own homes.

### BACKGROUND OF THE INVENTION

The use of stairlifts has become widespread in recent years as a means of overcoming problems of immobility associated with infirmity or old age which result in difficulties in climbing stairs. In larger buildings, such difficulties have long been overcome by the use of lifts or escalators but, until more recent years, no simple facilities were available which were useable in the smaller domestic environment. Consequently, the inability of certain personnel to climb or descend stairs in a safe manner without some form of assistance often proved to be a source of great inconvenience and handicap.

Consequently, stairlift devices have been developed which greatly simplify the task of ascending or descending stairs for the elderly and infirm. Generally, such devices comprise (a) passenger carrying means, which generally comprises seating means, wherein a person is seated for the purpose of ascending or descending the stairs, but may simply comprise means for carrying a standing passenger, such as a platform or similar attachment, (b) mounted guide means, by which the device is attached to the stairs and floor, and which defines the distance and direction of travel of the passenger carrying means, and (c) transporting means, which is operable to move the passenger carrying means along the guide means. Typically, in a simple arrangement, a rear attachment from, say, a chair would be movably located in the mounted guide means, which would possibly be in the form of a guide rail affixed to the stairs, and the chair would be caused to ascend or descend the stairs by driving means such as an electric motor, which would propel the chair along the guide means in the desired direction.

Not surprisingly, stairlifts have been found to be of great benefit in the field of health care and mobility and have significantly improved the quality of life for many people. However, there is a large and growing market for these devices which has yet to be fully exploited. Several reasons for this failure have become apparent, one of these, of course, being cost. Nevertheless, as the technology has developed, affordability has become less of an issue, and other factors have come to the fore. Not least among these is associated with the natural desire of the potential customer to inspect and test the selected device prior to purchase. Clearly, in such cases, the precise design of a particular model of stairlift can be extremely important to the customer, since certain models will be more suited to some individuals than others in terms of comfort and ease of use.

However, in order to be able to inspect such devices, the potential purchaser has no alternative but to travel to the premises of the manufacturer or retailer where various different designs of stairlift are available to be examined and tested in operation. Very evidently, the most obvious disadvantage of this situation is that the people who are the most likely to wish to purchase—and therefore to inspect—such devices are, by definition, those with problems of mobility who will, as a consequence, find the greatest difficulty and inconvenience in travelling significant distances to carry out such inspections. Inevitably, therefore, potential purchasers are likely to dismiss the idea of acquiring a stairlift at the outset for the very practical reasons which have been outlined.

### SUMMARY OF THE INVENTION

Thus, according to the present invention, there is provided a stairlift device which comprises passenger carrying means, substantially linear guide means, transporting means, and attachment means, said attachment means being adapted to enable the guide means to be attached to a section of a vehicle, thereby allowing for operation of the stairlift device whilst in attachment to the vehicle, the passenger carrying means being movable along the guide means by the transporting means when the device is in operation.

Typically, the guide means comprises a guide rail along which the passenger carrying means may travel. The passenger carrying means comprises any suitable means by which a passenger may be carried along the length of the guide means. Preferably, the passenger carrying means comprises seating means wherein a person is seated for the purpose of ascending or descending the stairs; said seating means is typically provided in the form of a suitably designed chair. Alternatively, the passenger carrying means may comprise means for carrying a standing passenger, such as a platform or similar attachment.

The passenger carrying means is connected to the guide means by way of mounting means, attached to the passenger carrying means, which may be located within the guide means. Movement of the mounting means along the path of travel of the guide means thereby causes the passenger carrying means to be propelled to its desired destination, said movement being facilitated by the transporting means. Said transporting means allows for propulsion of the passenger carrying means, and preferably takes the form of an electric motor, this generally being powered by means of an independent battery, although connection to a vehicle battery or to mains electricity do provide suitable alternatives. The transporting means may conveniently be located adjacent the passenger carrying means and is often integral with the mounting means. For convenience of storage, it is desirable that the mounting means should be detachable from the guide means when the stairlift device is not operational.

The stairlift device of the present invention necessarily requires the incorporation of attachment means to allow for attachment of the guide means to a suitable position on or within a vehicle body such that one end of the guide means is located in an elevated position relative to an opposed end of the guide means, thereby facilitating the simulation of a path of movement of a stairlift up and down a flight of stairs. The attachment means may take the form of any suitable form of bracket or the like which is adapted for attachment to a vehicle, and attachment may be made to any suitable vehicle, typically a motor vehicle such as an automobile, van or lorry. Most conveniently for present purposes is envisaged the attachment of the stairlift device within a boot of an automobile or a rear section of a van.

It is particularly preferred that said attachment means should allow for the attachment of said stairlift device to said vehicle whilst also facilitating the storage of the device within the vehicle and the ready deployment of the device to its operational position for demonstration purposes. Consequently, it is desired that the attachment means should be fixedly mounted to the vehicle and that the guide means should be movably mounted to the attachment means. Most conveniently, the guide means is slidably and rotatably attached to the attachment means, such that ready withdrawal from or insertion into the vehicle may be achieved by virtue of the slidable attachment, and the device may simply be deployed in a position whereby one end of the guide means is elevated relative to the other end of the guide means as a result of the rotatable attachment. This is generally most easily achieved by placing a lower end of the guide means on the ground, an upper end being attached to the attachment means which, in turn, is fixedly attached to the vehicle.

By virtue of the present invention, it is now possible for prospective purchasers of stairlifts to inspect and examine these devices at their own domestic residences. The device which is disclosed may be conveniently stored, for example, in a car boot or the rear section of a hatchback or van and taken to the desired location. The device can be simply deployed within a matter of minutes at a location adjacent the residence of the potential customer, tested by the person involved, and then stored away again in the vehicle for future use. As a consequence, the device can be inspected with far greater comfort and convenience by a greater number of people.

Embodiments of the present invention seek to overcome the difficulties associated with the inspection of the stairlifts of the prior art by enabling those with disabilities or infirmity to inspect and test stairlifts at the home, without the requirement to travel to other destinations. This is achieved by providing stairlifts and attachments which are readily transportable in a vehicle and may be simply assembled and coupled to the vehicle to allow inspection and demonstration of the devices and their mode of operation.

### BRIEF DESCRIPTION OF THE DRAWINGS

FIG. 1 is shows a general view of a stairlift device according to the invention; and

FIG. 2 shown a more detailed view of the attachment means.

### DETAILED DESCRIPTION OF THE PREFERRED EMBODIMENTS

The invention will now be described with respect to preferred embodiments described herein. It should be appreciated that these embodiments are for illustrative purposes only, and do not serve to limit the scope of the invention as defined by the claims.

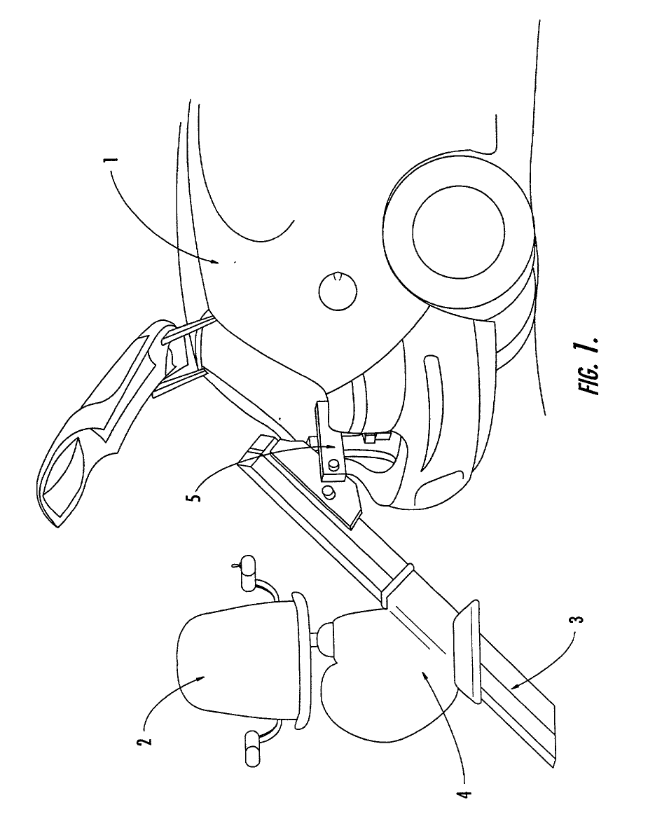

Referring firstly to FIG. 1, there is seen a stairlift device according to the invention, said device being attached to a boot section of a vehicle 1, and said device comprising passenger carrying means in the form of a chair 2, guide means provided by a guide rail 3, to which the chair 2 is attached by virtue of mounting means which is integral with a transporting means, in the form of a battery-powered motor provided under the chair, and located behind a housing at 4; the guide rail 3 is attached to the vehicle 1 by an attachment means comprising bracket 5, which is fixedly attached within the vehicle boot. For storage purposes, the chair 2 and the motor and mounting means provided at 4, all of which are comprised in a single unit, are detachable from the guide rail 3.

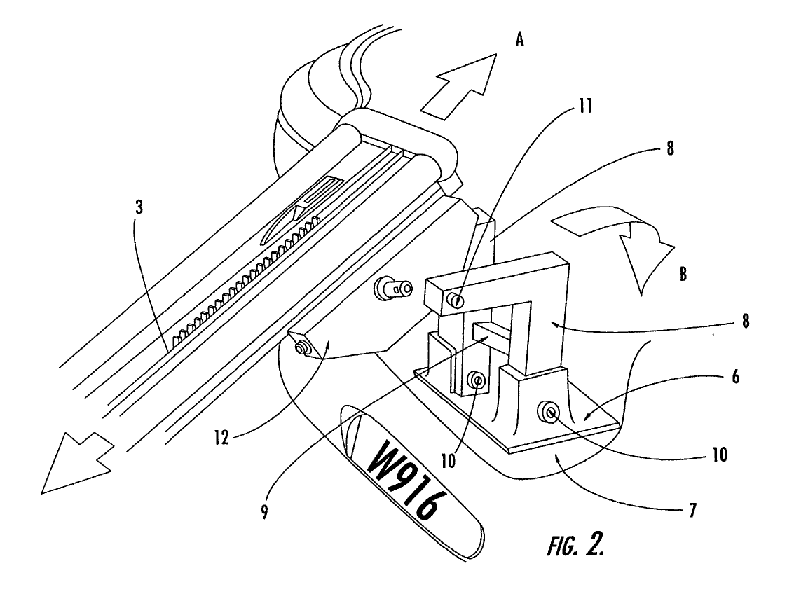

Turning now to FIG. 2, this depicts the attachment means which comprises a fixed member 6 attached to a floor 7 of the vehicle boot. The attachment means additionally comprises two angled members 8 incorporating a cross-member 9, said angled members being pivotally connected at one end, by way of two joints 10, to the fixed member 6 and pivotally connected at the other end, by way of two joints 11 (only one is visible in the figure) to a retaining member 12, said retaining member 12 being slidably attached to the guide rail 3 such that sliding movement may be achieved in the direction of the arrow A. Rotational movement occurs in the direction of the arrow B, by virtue of rotation about the joints 10 and 11, when a demonstration of the stairlift device has been concluded and it is desired to store the device away in the vehicle boot.

The invention has been described above with respect to the preferred embodiments. It should be understood that these embodiments are for illustrative purposes only, and do not serve to limit the scope of the invention as defined by the claims that follow.

That which is claimed:

1. A stairlift device which comprises passenger carrying means, substantially linear guide means, transporting means, and attachment means, said attachment means being adapted to enable the guide means to be attached to a section of a vehicle, thereby allowing for operation of the stairlift device whilst in attachment to the vehicle, the passenger carrying means being movable along the guide means by the transporting means when the device is in operation.

2. A stairlift device as claimed in claim 1 wherein said passenger carrying means comprises seating means.

3. A stairlift device as claimed in claim 2 wherein said seating means comprises a chair.

4. A stairlift device as claimed in claim 1 wherein said passenger carrying means comprises a platform.

5. A stairlift device as claimed in claim 1 wherein said guide means comprises a guide rail.

6. A stairlift device as claimed in claim 1 wherein said passenger carrying means is connected to the guide means by way of mounting means.

7. A stairlift device as claimed in claim 6 wherein said mounting means is attached to the passenger carrying means.

8. A stairlift device as claimed in claim 6 wherein said mounting means is located within the guide means.

9. A stairlift device as claimed in claim 6 wherein said transporting means is integral with said mounting means.

10. A stairlift device as claimed in claim 6 wherein said mounting means is detachable from said guide means when the stairlift device is not operational.

11. A stairlift device as claimed in claim 1 wherein said transporting means comprises an electric motor.

12. A stairlift device as claimed in claim 1 wherein said attachment means comprises a bracket which is adapted for attachment to a vehicle.

13. A stairlift device as claimed in claim 1 wherein said attachment means is fixedly mounted to a vehicle and said guide means is movably mounted to said attachment means.

14. A stairlift device as claimed in claim 13 wherein said guide means is slidably and rotatably attached to said attachment means.

15. A stairlift device as claimed in claim 12 wherein said attachment means comprises a fixed member and two angled members incorporating a cross-member, said angled members being pivotally connected at one end, by way of two joints, to said fixed member and pivotally connected at the other end, by way of two further joints, to a retaining member, said retaining member being slidably attached to the guide rail.

16. A stairlift device as claimed in claim 1 whenever permanently attached to a vehicle.

17. A vehicle including a stairlift device as claimed in claim 1.
